(19) United States
(12) Patent Application Publication
(10) Pub. No.: US 2013/0117502 A1
(43) Pub. Date: May 9, 2013

(54) METHOD FOR MANAGING SYSTEM FIRMWARE IN NAS SERVER

(71) Applicant: Hitachi-LG Data Storage Korea, Inc., Seoul (KR)

(72) Inventors: Sangki SON, Seoul (KR); Lyangwook CHO, Seoul (KR); Pilhwan YOON, Seoul (KR)

(73) Assignee: HITACHI-LG DATA STORAGE KOREA, INC., Seoul (KR)

(21) Appl. No.: 13/672,448

(22) Filed: Nov. 8, 2012

(30) Foreign Application Priority Data
Nov. 8, 2011 (KR) 10-2011-0115732

(51) Int. Cl. G06F 12/16

(52) U.S. Cl. 711/103; 711/114; 711/E12.008; 711/E12.103

(57) ABSTRACT

A method for managing system firmware in a network attached storage (NAS) server comprises: synchronizing system firmware stored one or more of two or more hard disks (HDDs) and system firmware stored in a nonvolatile memory with each other; and confirming whether or not at least one valid HDD in which the system firmware is stored exists, when an HDD is replaced; and copying the system firmware stored in the nonvolatile memory into the replaced HDD, when it is confirmed that the valid HDD does not exist. In the method, when a watch dog timer is reset, the system firmware stored in the nonvolatile memory is synchronized, based on the system firmware stored in the HDD, by confirming whether or not the system firmware of the HDD and the system firmware of the nonvolatile memory are synchronized with each other.

This nonprovisional application claims priority under 35 U.S.C. §119(a) on Patent Application No. 10-2011-0115732 filed in Republic of Korea on Nov. 8, 2011 the entire contents of which are hereby incorporated by reference.

### BACKGROUND

1. Field

This document relates to a method for managing system firmware in a network attached storage (NAS) server, which provides a hot swap function of enabling a hard disk to be replaced even while a system is operating.

2. Related Art

Network attached storage (NAS) servers for implementing personal cloud services are widely spread.

A plurality of hard disks (HDDs) are included as large-capacity storages in the NAS server, and a redundant arrays of inexpensive disks (RAID) technique is applied to the plurality of HDDs for the purpose of quick access of data, stability of data, recovery of data, etc. The RAID technique enables a plurality of HDDs as one large-capacity storage.

System firmware necessarily required to boot a system is stored in the HDDs. The system firmware is stored in a system area distinguished from a specific area which users' accesses are impossible, i.e., a general user data area.

The NAS server provides a hot swap function of enabling a user to arbitrarily replace an HDD(s) even while the system is operating. In a case where RAID1 is applied to the NAS server, the user can freely replace one of two HDDs using the hot swap function. In a case where RAID5 is applied to the NAS server, the user can freely replace two of three HDDs using the hot swap function.

However, if both the HDDs are replaced in the NAS sever to which the RAID1 is applied due to user's carelessness, etc., the system firmware stored in the system area of the HDDs cannot be normally recovered. Hence, there occurs a system hang in which the operation of the system is stopped.

In a case where three or more HDDs are simultaneously replaced in the NAS server to which the RAID5 is applied, the system hang also occurs. Therefore, it is required to propose an efficient plan for preventing the system hang.

### SUMMARY

An aspect of this document is to provide a method for managing system firmware in a network attached storage (NAS) server, which can safely manage the NAS server without any system hang for user's activities out of an allowance range.

In an aspect, a method for managing system firmware in a NAS server comprises: synchronizing system firmware stored one or more of two or more hard disks (HDDs) and system firmware stored in a nonvolatile memory with each other; and confirming whether or not at least one valid HDD in which the system firmware is stored exists, when an HDD is replaced; and copying the system firmware stored in the nonvolatile memory into the replaced HDD, when it is confirmed that the valid HDD does not exist.

A redundant arrays of inexpensive disks (RAID) technique is applied to the two or more hard disks.

The synchronizing includes confirming whether or not the system firmware of the HDD and the system firmware of the nonvolatile memory are synchronized with each other, when a watch dog timer is reset.

The synchronizing includes synchronizing the system firmware of the nonvolatile memory, based on the system firmware stored in the HDD.

The system firmware is stored in the system areas of the HDD and the flash memory, which an users' access is impossible.

Software related to system environment configuration is further stored in the system area.

The method further comprises copying the system firmware stored in the valid HDD into the replaced HDD, when it is confirmed that the valid HDD exists.

In another aspect, a NAS server comprises: two or more HDDs; a memory configured to store system firmware stored in one or more of the two or more HDDs; and a controller configured to synchronize the system firmware of the HDDs and system firmware of a nonvolatile memory with each other when a watch dog timer is reset, and copy the system firmware stored in the nonvolatile memory into a replaced HDD when the HDD is replaced and it is confirmed that at least one valid HDD in which the system firmware is stored exists.

In the method for managing system firmware in a NAS system, although hard disks out of an allowable range are arbitrarily replaced due to user's carelessness while a system is operating, the system firmware can be normally recovered, so that it is possible to prevent the occurrence of a system hang and to safely manage the NAS system.

### BRIEF DESCRIPTION OF THE DRAWINGS

FIG. 1 illustrates a state in which a host, a device and a plurality of clients are connected to a network attached storage (NAS) server.

FIG. 2 illustrates a configuration of a NAS server to which the present invention is applied.

FIG. 3 schematically illustrates an exemplary embodiment in which the NAS server manages system firmware according to the present invention.

FIG. 4 is a flowchart illustrating a method for managing system firmware in a NAS server according to an exemplary embodiment of the present invention.

### DETAILED DESCRIPTION

The above objects, characteristics, and merits of this document will become more apparent from the following detailed description taken in conjunction with the accompanying drawings. This document can be modified in various ways and can have several embodiments. Hereinafter, some of the embodiments are shown in the accompanying drawings and described in detail with reference to the drawings. The same reference numerals, as a general rule, designate the same elements throughout the specification. Further, a detailed description of the known functions or constructions will be omitted if it is deemed to make the gist of this document unnecessarily vague. It is also to be noted that numbers (e.g., first and second) used in the description of this document are only identification symbols for distinguishing one element from the other element. The above and other objects, features and advantages of the present invention will become apparent from the following detailed description taken with the accompanying drawings. As the invention allows for various changes and numerous embodiments, particular embodiments will be illustrated in the drawings and described in detail in the written description. Like reference numerals designate like elements throughout the specification. In the following description, detailed descriptions of well-known functions or constructions will be omitted since they would obscure the invention in unnecessary detail.

Hereinafter, a method for managing system in a network attached storage (NAS) server according to an exemplary embodiment of the present invention will be described in detail with reference to the accompanying drawings.

First, the method for managing system firmware according to the exemplary embodiment of the present invention can be applied to various types of NAS servers which are provided with, for example, a plurality of hard disks (HDDs) and to which a hot swap function and a redundant arrays of inexpensive disks (RAID) technique are applied.

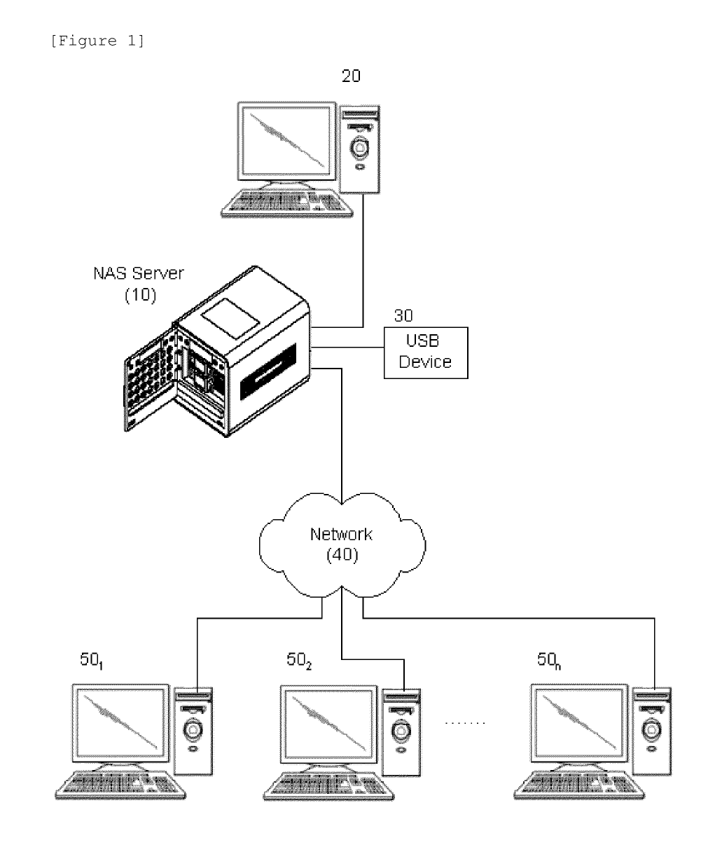

As shown in FIG. 1, a NAS server 10 may be connected to a personal computer 20, a universal serial bus (USB) device 30, etc. through an interface module. The NAS server 10 may be connected to a plurality of clients 50₁ to 50ₙ distant from a remote place through a network 40 such as Internet. These devices can share data with the NAS server 10 by recording or reading the data on or from a plurality of HDDs provided in the NAS server 10.

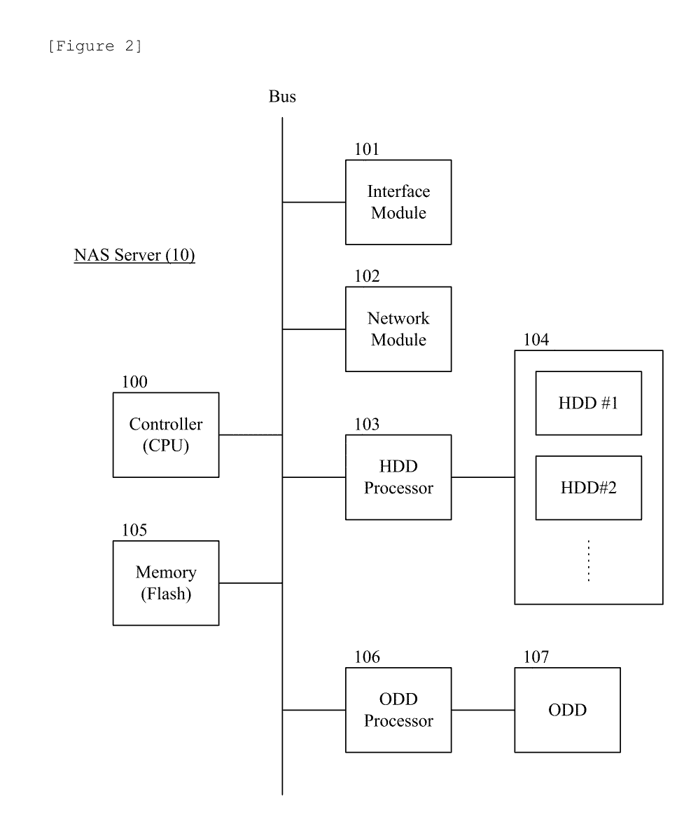

As shown in FIG. 2, the NAS server 10 may comprise a controller 100, an interface module 101, a network module 102, an HDD processor 103, two or more HDDs (HDD#1 and HDD#2) 104, a nonvolatile memory 105, an optical disk drive (ODD) processor 106, an ODD 107, etc. The controller 100 may include, for example, a control processing unit (CPU), etc. The nonvolatile memory 105 may include, for example, a flash memory, etc.

In the present invention, a specific area of the flash memory 105 is assigned as a system area which users' accesses are impossible so as to be distinguished from a normal data area in which general data is recorded.

In a case where the RAID technique is applied to the plurality of HDDs, the CPU records software related to system firmware necessary for a system booting operation, etc. and/or system environment configuration to be distributed and overlapped on the plurality of HDDs, so that data can be recovered even when an error occurs in one or more HDDs.

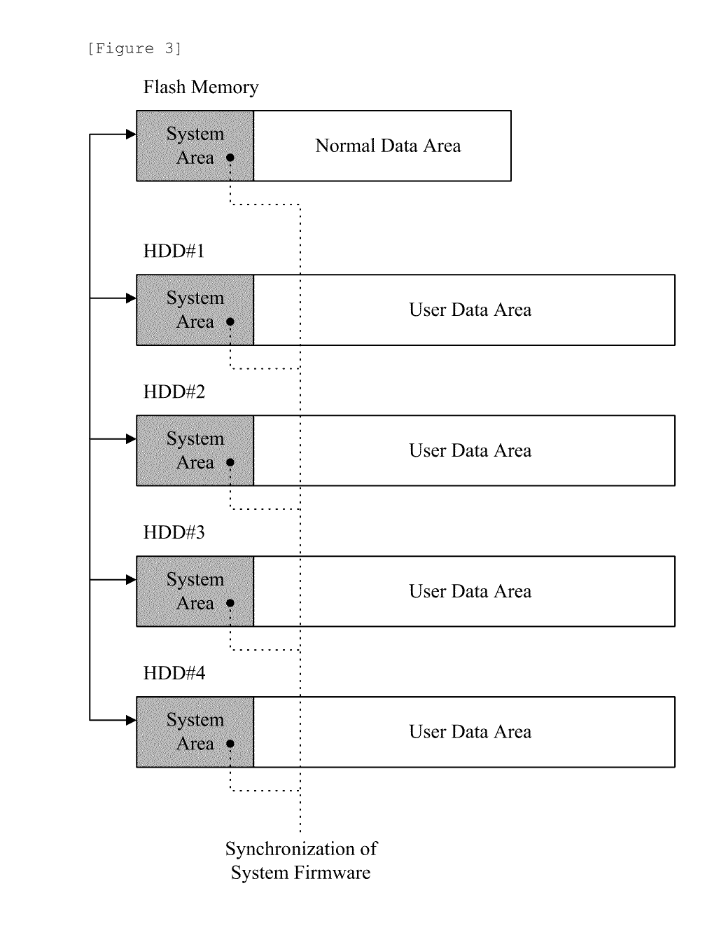

As shown in FIG. 3, the CPU copies the system firmware stored in the system area of the HDD into the system area of the flash memory.

For example, when a watch dog timer is reset, the CPU confirms whether or not system firmware stored in the system area of the HDD and system firmware stored in the system area of the flash memory are synchronized with each other. In a case where the system firmware stored in the system area of the HDD is different from that stored in the system area of the flash memory, the CPU performs a synchronization operation of replacing the system firmware of the flash memory with the system firmware of the HDD.

The system firmware of the flash memory may be copied in the state in which the system firmware of the flash memory is synchronized with the system firmware of the HDD at the time when the NAS server is released. Alternatively, the system firmware of the flash memory may be copied from the HDD at the time when the system booting operation is normally completed.

In the system area of the HDD and the system area of the flash memory, various types of software related to the system environment configuration, etc. may be synchronized and managed in the state in which the various types of software are synchronized with one another, as well as the system firmware necessary for the system booting operation.

The CPU provides a HDD hot swap function so that a user can replace an HDD even while a system is operating. For example, if one of two HDDs is replaced in the state in which RAID1 is applied to the NAS system, the CPU decides the HDD hot swap function as one within an allowance range. If one or two of four HDDs are replaced in the state in which RAID5 is applied to the NAS system, the CPU decides the HDD hot swap function as one within an allowance range. Thus, the CPU copies the system firmware, the software, etc., which are recorded on the HDDs not replaced, into the placed HDD.

On the other hand, if both of the two HDDs are replaced in the state in which the RAID1 is applied to the NAS server, or if three or more of the four HDDs are replaced in the state in which the RAID5 is applied to the NAS server, the CPU decides the HDD swap function as one out of the allowable range, and automatically performs a series of operations of copying the system firmware, the software, etc., recorded in the flash memory, into the replaced HDDs. This will be described in detail as follows.

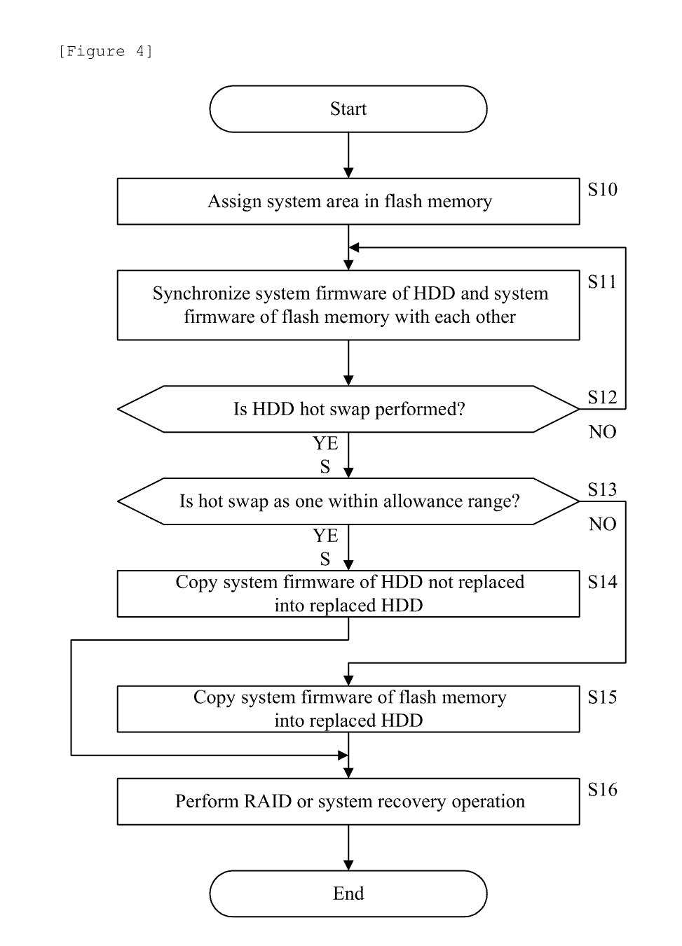

FIG. 4 is a flowchart illustrating a method for managing system firmware in a NAS server according to an exemplary embodiment of the present invention.

For example, as described above, a recording area which users' accesses are impossible is assigned to be distinguished from a system area of the flash memory included in the NAS server (S10). The system area of the flash memory may be previously assigned in a manufacturing process of the NAS server, or may be assigned to have a predetermined size by the CPU at the time when an initial system booting operation of the NAS server is completed.

For example, the system firmware stored in the system area of the HDD may be previously copied and stored in the system area of the flash memory at the time when the NAS server is manufactured and released. Alternatively, the system firmware stored in the system area of the HDD may be copied and stored in the system area of the flash memory at the time when the initial system booting operation of the NAS server is completed.

Meanwhile, when the watch dog timer is reset, the CPU performs a series of operations of comparing system firmware stored in the system area of the HDD and system firmware stored in the system area of the flash memory, and synchronizing the system firmware stored in the system area of the HDD and the system firmware stored in the system area of the flash memory with each other (S11).

If the watch dog timer is reset, the CPU first confirms, in real time, whether or not the system firmware of the HDD and the system firmware of the flash memory are synchronized with each other. In a case where the system firmware of the HDD and the system firmware of the flash memory are not synchronized with each other, the CPU may separately perform a synchronization operation of renewing the system firmware, based on the system firmware stored in the HDD. In this case, the synchronization operation may be performed in the state in which another operation is stopped or may be performed as a background in the state in which another operation is also performed.

The synchronization operation is performed even when software related to the system environment configuration is updated, so that the software updated in the HDD can be stored in the system area of the flash memory.

Meanwhile, the CPU monitors whether or not there is performed a hot swap function in which a user replaces an HDD while the operation of the NAS server is being performed (S12). In a case where the replacement of the HDD is detected by a separate sensor (not shown), etc., the CPU decides that the hot swap function has been performed, and decides whether or not the hot swap function is one within an allowance range (S13).

If one of two HDDs is replaced in the state in which the RAID1 is applied to the NAS server or if one or two of four HDDs are replaced in the state in which the RAID5 is applied to the NAS server, the CPU decides the hot swap function as one within the allowable range, and copies the system firmware, etc., which are stored in the system area of the valid HDD not replaced, into the system area of the replaced HDD (S14).

On the other hand, if both of the two HDDs are replace in the state in which the RAID1 is applied to the NAS server or if three or more of the four HDDs are replaced in the state in which the RAID5 is applied to the NAS server, the CPU decides the hot swap function as one out of the allowable range, and copies the system firmware stored in the system area of the flash memory, etc. into the system area of the replaced HDD (S15).

The CPU performs an operation of copying data of the HDD not replaced according to the previously set RAID mode into the system area of the replaced HDD, thereby normally recovering the system (S16).

Thus, although the user arbitrarily replaces HDDs out of the allowance range using the hot swap function while the system is operating, the system firmware is automatically recovered, thereby efficiently prevent a system hang.

While we have shown and described several embodiments in accordance with the present invention, it is understood that the same is not limited thereto but is susceptible of numerous changes and modifications as known to those skilled in the art, and we therefore do not wish to be limited to the details shown and described herein but intended to cover all such changes and modifications as are encompassed by the scope of the appended claims.

What is claimed is:

1. A method for managing system firmware in a network attached storage (NAS) server, comprising:
synchronizing system firmware stored one or more of two or more hard disks (HDDs) and system firmware stored in a nonvolatile memory with each other; and
confirming whether or not at least one valid HDD in which the system firmware is stored exists, when an HDD is replaced; and
copying the system firmware stored in the nonvolatile memory into the replaced HDD, when it is confirmed that the valid HDD does not exist.

2. The method of claim 1, wherein a redundant arrays of inexpensive disks (RAID) technique is applied to the two or more hard disks.

3. The method of claim 1, wherein the synchronizing includes confirming whether or not the system firmware of the HDD and the system firmware of the nonvolatile memory are synchronized with each other, when a watch dog timer is reset.

4. The method of claim 1, wherein the synchronizing includes synchronizing the system firmware of the nonvolatile memory, based on the system firmware stored in the HDD.

5. The method of claim 1, wherein the system firmware is stored in the system areas of the HDD and the flash memory, which an users' access is impossible.

6. The method of claim 5, wherein software related to system environment configuration is further stored in the system area.

7. The method of claim 1, further comprising copying the system firmware stored in the valid HDD into the replaced HDD, when it is confirmed that the valid HDD exists.

8. A NAS server, comprising:
two or more HDDs;
a memory configured to store system firmware stored in one or more of the two or more HDDs; and
a controller configured to synchronize the system firmware of the HDDs and system firmware of a nonvolatile memory with each other when a watch dog timer is reset, and copy the system firmware stored in the nonvolatile memory into a replaced HDD when the HDD is replaced and it is confirmed that at least one valid HDD in which the system firmware is stored exists.

9. The NAS server of claim 8, wherein a RAID technique is applied to the two or more hard disks.

10. The NAS server of claim 8, wherein, when the watch dog timer is reset, the controller confirms whether or not the system firmware of the HDD and the system firmware of the nonvolatile memory are synchronized with each other, and when the system firmware of the HDD and the system firmware of the nonvolatile memory are not synchronized with each other, the controller synchronizes the system firmware of the nonvolatile memory, based on the system firmware stored in the HDD.

11. The NAS server of claim 8, wherein the system firmware is stored in the system areas of the HDD and the memory, which users' accesses are impossible.

12. The NAS server of claim 11, wherein the controller further stores software related to system environment configuration in the system area.

13. The NAS server of claim 8, wherein, when an HDD is replaced and it is confirmed that the valid HDD exists, the controller copies the system firmware stored in the valid HDD into the replaced HDD.
